(19) United States
(12) Patent Application Publication
(10) Pub. No.: US 2015/0363800 A1
(43) Pub. Date: Dec. 17, 2015

(54) MERCHANT PERFORMANCE EVALUATION IN A COMPUTER NETWORKED ENVIRONMENT

(71) Applicant: GOOGLE INC., Mountain View, CA (US)

(72) Inventors: Jieyan Fan, Fremont, CA (US); Niranjan Heddese Sitaram Shastry, Sunnyvale, CA (US); Sze Chit Ho, Mountain View, CA (US); Yuan Zhuge, Mountain View, CA (US); Timothy John Wright, San Francisco, CA (US)

(73) Assignee: GOOGLE INC., Mountain View, CA (US)

(21) Appl. No.: 14/227,800

(22) Filed: Mar. 27, 2014

(51) Int. Cl. G06Q 30/02

(52) U.S. Cl. CPC G06Q 30/0202

(57) ABSTRACT

Systems and methods of evaluating merchant performance in a computer networked environment are provided. A data processing system can obtain ecommerce traffic data identifying a product, and can obtain, separately from the ecommerce traffic data, catalog data not present in the ecommerce traffic data. Subsequent to obtaining the ecommerce traffic data and the catalog data, the data processing system can receive a query for a report. The query can include a key identifying the product. Using the key and responsive to the query for the report, the data processing system can direct a plurality of report generation servers to join at least part of the ecommerce traffic data with at least part of the catalog data to create joined data. The data processing system can generate the report, including the joined data, and the data processing system can provide the report to a merchant computing device.

### BACKGROUND

In a computer networked environment such as the internet, entities such as people or companies provide information for public display on web pages or other online documents. The documents can include information provided by the entities via a computing device for display on the internet. Content can also be provided by third parties for display on the documents together with the information provided by the entities. Thus, a person viewing a document can access the information that is the subject of the document, as well as third party content that may or may not be related to the subject matter of the document.

### SUMMARY

At least one aspect is directed to a computer implemented method of evaluating merchant performance in a computer networked environment. The method can obtain, by a data processing system having a query evaluation module and a plurality of report generation servers, via a computer network, ecommerce traffic data. The ecommerce traffic data can identify a product. The method can obtain, separately from the ecommerce traffic data, by the data processing system via the computer network, catalog data not present in the ecommerce traffic data. The method can receive, by the data processing system from a merchant computing device via the computer network and subsequent to obtaining both the ecommerce traffic data and the catalog data, a query for a report. The query can include a key identifying the product. The method can include directing, by the query evaluation module using the key, responsive to the query for the report, the plurality of report generation servers to join at least part of the ecommerce traffic data with at least part of the catalog data to create joined data, and can include generating, by the data processing system and responsive to the query for the report, the report for the product. The report can include the joined data. The method can provide, by the data processing system, via the computer network, the report to the merchant computing device.

At least one aspect is directed to a system of evaluating merchant performance in a computer networked environment. The system can include a data processing system having a query evaluation module and a plurality of report generation servers that can obtain ecommerce traffic data identifying a product, and can obtain, separately from the ecommerce traffic data, catalog data not present in the ecommerce traffic data. The system can receive, from a merchant computing device via the computer network, a query for a report. The query can include a key identifying the product. The system can direct, by the query evaluation module using the key, responsive to the query for the report, the plurality of report generation servers to join at least part of the ecommerce traffic data with at least part of the catalog data to create joined data. The system can generate, responsive to the query, the report for the product, the report including the joined data, and the system can provide, via the computer network, the report to the merchant computing device.

At least one aspect is directed to a computer readable storage medium storing instructions that when executed by one or more data processors, cause the one or more data processors to perform operations. The operations can include obtaining, via a computer network, ecommerce traffic data. The ecommerce traffic data can identify a product. The operations can include obtaining, separately from the ecommerce traffic data, via the computer network, catalog data not present in the ecommerce traffic data, and receiving, from a merchant computing device via the computer network, a query for a report. The query can include a key identifying the product. The operations can include directing, responsive to the query for the report, the plurality of report generation servers to join at least part of the ecommerce traffic data with at least part of the catalog data to create joined data, and generating, responsive to the query for the report, the report for the product. The report can include the joined data. The operations can include providing, via the computer network, the report to the merchant computing device.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram depicting one example environment to evaluate merchant performance in a computer networked environment, according to an illustrative implementation;

FIG. 2 is a display depicting one example of a report evaluating merchant performance, according to an illustrative implementation;

FIG. 3 is a flow diagram depicting an example method of evaluating merchant performance in a computer networked environment, according to an illustrative implementation; and

FIG. 4 is a block diagram illustrating a general architecture for a computer system that may be employed to implement elements of the systems and methods described and illustrated herein, according to an illustrative implementation.

### DETAILED DESCRIPTION

Following below are more detailed descriptions of various concepts related to, and implementations of, methods, apparatuses, and systems of providing information via a computer network. The various concepts introduced above and discussed in greater detail below may be implemented in any of numerous ways, as the described concepts are not limited to any particular manner of implementation.

Systems and methods of the present disclosure relate generally to evaluating merchant or information resource performance in a computer networked environment. To evaluate ecommerce performance, a merchant can communicate via the internet or other computer network to request a report having analytical data for one or more products or information resources. For example, using a merchant computing device, a shoe company may communicate with a data processing system to request or query for a report pertaining to sales of a product, such as a type of shoe, via the computer network.

The data processing system can receive the request for the report, and can obtain ecommerce traffic data as well as catalog data relating to the product. For example, the ecommerce traffic data can indicate a number of sales of the product, and the catalog data can include details about the product, such as brand information, product name, category, brand, description, price, or other product metadata. The ecommerce traffic data and the catalog data can be stored in one or more databases accessible by one or more servers of the data processing system.

Responsive to the request for the report, the data processing system can identify the servers associated with databases having the ecommerce traffic data and the catalog data relevant to a product identified in the request, and can instruct the servers to retrieve, join, or merge the ecommerce traffic data with the catalog data to create the report. The report can include information about the product identified in the report, and the report can be provided from the data processing system to a merchant computing device for display. The report can be generated by joining completely or partially mutually exclusive data (e.g., the ecommerce traffic data and the catalog data) from different databases to create the data included in the report at or responsive to the time of the request, rather than pre-joining the data prior to receiving a request to generate a report. The report can indicate revenue data related to a product, or other data regarding the sales, use, or popularity of a product (e.g., a good or service) via an information resource through a computer network, such as a web page that sells shoes via the internet, for example.

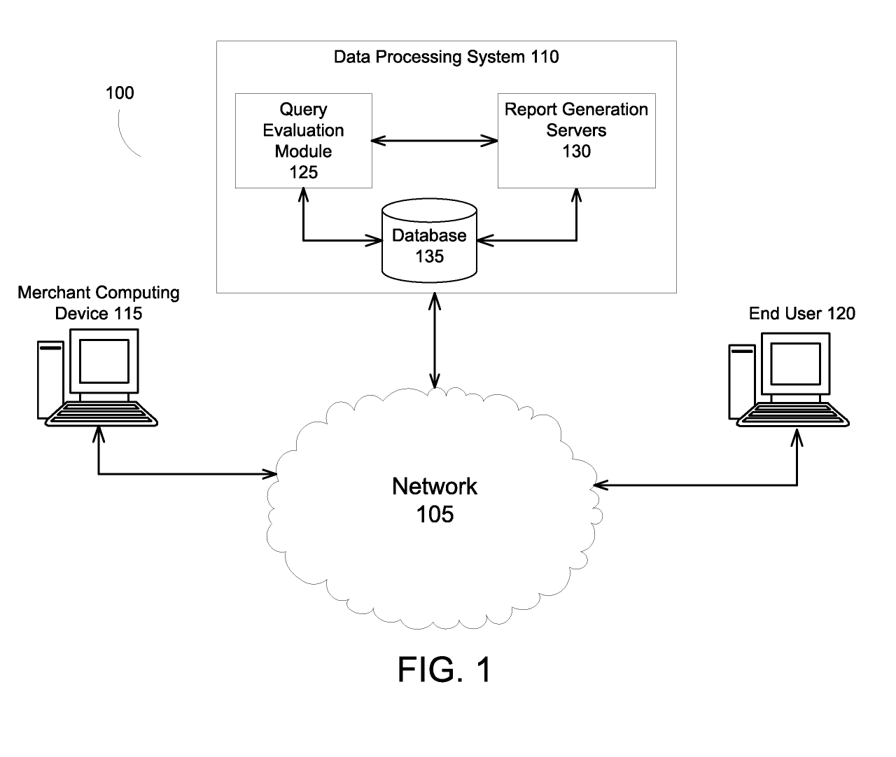

FIG. 1 illustrates an example system 100 for evaluating merchant performance via at least one computer network, such as the network 105. The network 105 can include computer networks such as the internet, local, wide, metro or other area networks, intranets, satellite networks, other computer networks such as voice or data mobile phone communication networks, and combinations thereof. The network 105 can include or constitute a display network, e.g., a subset of information resources available on the internet that are associated with a content placement system, or that are eligible to include third party content items as part of a content item placement campaign. The system 100 can also include at least one data processing system 110, e.g., at least one logic device such as a computing device or server having a processor to communicate via the network 105, for example with at least one merchant computing device 115 or at least one end user computing device 120.

The data processing system 110 can include at least one server. For example, the data processing system 110 can include a plurality of servers located in at least one data center or server farm. In one implementation, the data processing system 110 includes an information resource analytics system that generates statistical or other data (e.g., reports) about goods or services available via information resources of the network 105. The data processing system 110 can include at least one query evaluation module 125, at least one report generation server 130, and at least one database 135. The query evaluation module 125 and the report generation servers 130 can each include at least one processing unit, server, virtual server, circuit, engine, agent, appliance, or other logic device such as programmable logic arrays configured to communicate with the database 135 and with other computing devices (e.g., the merchant computing device 115) via the network 105.

The query evaluation module 125 and the report generation servers 130 can include or execute at least one computer program or at least one script. The query evaluation module 125 and the report generation servers 130 can be separate components, a single component, or part of the data processing system 110. The query evaluation module 125 and the report generation servers 130 can include combinations of software and hardware, such as one or more processors configured to execute one or more scripts to obtain ecommerce traffic data and catalog data, receive requests for reports, direct at least some of the report generation servers to join at least part of the ecommerce traffic data and the catalog data to create joined data, generate the report including the joined data, or provide the report via the network 105 to the merchant computing device 115 for display to a merchant, for example.

The merchant computing devices 115 can include personal computers, servers, mobile computing devices, or other computing devices operated for example by a merchant (e.g., a website operator, or vendor of goods and services via the network 105) to provide products (e.g., goods or services) for display, use, or sale via the network 105. For example, the merchant computing device 115 can be associated with a web page (or other information resource) operator who provides products for sale, distribution, or display on the web page (or other information resource) via the network 105. The merchant computing device 115 can operate, (or belong to the same company or otherwise be associated with) the website of a company and can provide products of the company for display or sale on web pages of the website. At least one end user computing device 120 can access the web pages via the network 105 to view, convert, access, or purchase the products.

The end user computing devices 120 can include computing devices configured to communicate via the network 105 to display data such as the content provided by the merchant computing device 115. The end user computing device 120 and the merchant computing device 115 can include desktop computers, laptop computers, tablet computers, smartphones, personal digital assistants, mobile devices, end user computing devices, consumer computing devices, servers, clients, and other computing devices. The end user computing device 120 and the content publisher computing device 115 can include user interfaces such as microphones, speakers, touchscreens, keyboards, pointing devices, a computer mouse, touchpad, or other input or output interfaces.

The data processing system 110 can include the query evaluation module 125 or the report generation servers 130 as part of one or more servers of an online analytics report generation system to evaluate the performance of a merchant, products, or information resources associated with the merchant computing device 115 via the network 105. The data processing system 110 can generate a report including analytical data about the operation, use, renderings, availability or access of the information resource or products displayed or available via the information resource, and can provide the report to the merchant computing device 115 or an end user computing device 120 via the network 105 for display by the merchant computing device 115 or by the end user computing device 120.

The query evaluation module 125 or the report generation servers 130 can be part of, or can include scripts executed by, one or more servers in the data processing system 110 (e.g., an analytics report generation system) to identify revenue or other data related to sale or use of a product via at least one information resource associated with the merchant computing device 115. The query evaluation module 125 can be part of the same or a different server as one or more of the report generation servers 130 in the data processing system 110. The query evaluation module 125 can identify requests for reports received via the network 105 from the merchant computing device 115 and can obtain information from data included in the request, such as information identifying one or more products to be included in an analytical report. The query evaluation module 130 can determine a product name or identifier from information included in a query or request for a report.

The system 100 can evaluate merchant performance, for example by providing sales or revenue data of products associated with the merchant computing device 115. In some implementations, the data processing system 110 obtains or receives ecommerce traffic data. The ecommerce traffic data can be received from one or more merchant computing devices 115 associated with a merchant, and can relate to sales of a product associated with the merchant. For example, the merchant can be a shoe retailer associated with a plurality of merchant computing devices 115 that host one or more websites. The merchant computing devices 115 can be owned by the merchant, e.g., to provide web pages directly operated by the shoe retailer and offering only shoes or other products of that retailer for sale. The merchant computing devices 115 can also be operated by third party entities, for example, an online website or app owned by a merchant that sells a variety of products of a variety of different merchants.

The ecommerce traffic data can indicate a sale of a product. For example, the end user computing device 120 can access a web page of the merchant computing device 115 via the network 105 to purchase a pair of shoes (or other product or service) offered for sale on the web page. Upon, for example, the completion of a purchase of a pair of shoes, the merchant computing device 115 can provide ecommerce traffic data to the data processing system 110 indicating the sale of a pair of shoes. The ecommerce traffic data can indicate the product (e.g., the type of shoes) with a product identifier and can indicate one or more sales or conversions associated with the product. The ecommerce traffic data may or may not indicate additional data, such as the price paid for the product. The ecommerce traffic data can indicate non-sale or other conversions such as clicking a link of a web page, app, or other information resource to access data about a product, a rendering of an information resource, or registration or sign up for a good or service, for example.

The data processing system 110 can receive ecommerce traffic data from a plurality of merchant computing devices 115 on a rolling or ongoing basis. For example, upon a sale or other conversion involving the product on an information resource such as a web page, website, or app, at least one merchant computing device 115 can provide the ecommerce traffic data to the data processing system 110 via the network 105. The data processing system 110 can also receive ecommerce traffic data periodically (e.g., hourly, daily, weekly, or monthly) from a plurality of merchant computing devices 115.

The data processing system 110 can collect or aggregate ecommerce traffic data over time, categorize the ecommerce traffic data (e.g., by product type, keys, or other product identifier) and can store the ecommerce traffic data in one or more databases 135 associated with or accessible by the report generation servers 130. The ecommerce traffic data obtained by the data processing system 110 can indicate a large number of sales of a large number of different products. For example, the data processing system 110 can receive millions of instances of ecommerce traffic data indicating sales of products (including goods or services) via the network 105 from a large number (e.g., hundreds of thousands or millions) of different merchant computing devices 115 associated with different merchants. The data processing system 110 or a component thereof such as the query evaluation module 125 assigns one or more report generation servers 130 or databases 135 to store or process the ecommerce traffic data. These numbers, e.g., hundreds of thousands or millions, are examples, and the data processing system 110 is scalable to operate both above and below these example ranges. For example, the data processing system 110 can be dedicated to a single merchant associated with one to tens of merchant computing devices 115.

The data processing system 110 can obtain catalog data. For example, the data processing system 110 (or component thereof such as at least one report generation server 130) can receive catalog data from one or more merchant computing devices 115. The catalog data can identify a number of different products associated with a number of different merchants. For example, a first merchant computing device 115 associated with a first merchant can transmit first catalog data via the network 105 to the data processing system. The first catalog data can include product identifiers (e.g., keys) that identify one or more products associated with the first merchant, such as goods or services offered for sale by the first merchant via the network 105 either directly (e.g., through a website operated by the first merchant) or indirectly (e.g., through a website operated by a third party). A second merchant computing device 115 associated with a second merchant independent of the first merchant can provide second catalog data to the data processing system 110. The second catalog data can identify produce associated with the second merchants.

In addition to identifying products, the catalog data can also identify product name, product price, product, category, a product description, brand, or price data of one or more products. In some implementations, the catalog data is mutually exclusive from the ecommerce traffic data. For example, the ecommerce traffic data can indicate a sale of a product via the network 105 when or after the sale transaction occurs. The ecommerce traffic data in this example can identify a product with an identifier or key and can indicate that a sale occurred. The catalog data (e.g., product price, description, or name) can be absent from the ecommerce traffic data. The ecommerce traffic data can also be absent from the catalog data. For example, in some implementations the catalog data does not include any data indicating an actual sale that occurred between the merchant computing device 115 and the end user computing device 120 via the network 105. Instead, the catalog data can include information about products available for purchase via the network 105 without including any information about any sales or other conversions. Data present in the catalog data may not be included in the ecommerce traffic data, and data present in the ecommerce traffic data may not be included in the catalog data. As the catalog data can include some data applicable to different instances of sales of the products, each instance of the ecommerce traffic data need not include all of the product metadata or details, which can instead by found in the catalog data.

The data processing system 110 can receive the catalog data separately from the ecommerce traffic data. For example, a merchant may be interested in joining an online analytical service to receive reports about the sales or activity of the merchant's products via the network 105. Using a first merchant computing device 115, the merchant can join such a service and provide catalog data to the data processing system 110. The catalog data indicates products of the merchant as well as other catalog data about those products (e.g., product descriptions, retail price, or product name). The catalog data does not, for example, indicate any actual sales or conversions, instead including data about products offered for sale via the network 105. The data processing system 110 obtains the catalog data and stores it in one or more databases 135 where it can be accessed or retrieved by one or more report generation servers 130. The catalog data can be provided to (and obtained by) the data processing system 110 on a periodic, rolling or continuous basis (e.g., hourly, daily, weekly, or monthly). For example, the merchant can update catalog data by adding or removing products or by changing price data. The data processing system 110 can receive this updated catalog data from at least one merchant computing device 115 associated with the merchant. The catalog data can be sent less frequently to the data processing system 110, relative to each instance of the ecommerce traffic data sent to the data processing system 110.

Either before or after the first merchant computing device 115 provides the catalog data to the data processing system, the first merchant computing device 115 or other merchant computing devices 115 associated with the merchant can also provide the ecommerce traffic data to the data processing system. For example, the first merchant computing device 115 can provide catalog data to the data processing system 110 indicating that an identified type of shoe (e.g., sneaker model #123) has a retail price of $100. The catalog data in this example does not indicate that the shoe was sold. Subsequently, for example, a second merchant computing device 115 that operates or is otherwise associated with a web page or other information resource can participate in a transaction with an end user computing device 120 where one pair of sneaker model #123 is sold. In this example, the second merchant computing device 115 can provide ecommerce traffic data to the data processing system 110 indicating that one pair of the merchant's sneaker model #123 was sold.

The ecommerce traffic data may or may not indicate the price paid to purchase the product (e.g., $100), which if not present in the ecommerce traffic data can be indicated instead in the catalog data. The data processing system 110 can assign the catalog data to at least one database 135 and can assign the ecommerce traffic data to the same or a different database 135. The databases 135 can be accessed by the same or different report generation servers 130. The data processing system 110 can receive ecommerce traffic data from a number (e.g., from tens to hundreds of thousands or more) of merchant computing devices 115 indicating individual sales of the merchant's sneaker model #123 (or any other product) via the network 105.

The merchant associated with the sneaker model #123 may wish to obtain a report having analytical data regarding the distributed sales of sneaker model #123 through the network 105. The analytical data can be based on the ecommerce traffic data and the catalog data, and can indicate an aggregate number of sales of one or more products, gross or net revenue generated by sales of one or more products, or other product information, such as countries, cities, or regions where sales occur or are concentrated. The report can include ecommerce traffic data or catalog data. The report does not individually or personally identify any individual end users.

The data processing system 110 can receive a query for a report. For example, the query evaluation model 125 can receive the query, or request, from the merchant computing device 115 via the network 105. The query for the report can include a key or other product identifier to identify one or more products associated with a merchant, such as sneaker model #123. In some implementations, the query for the report does not include ecommerce traffic data or catalog data beyond an identification of one or more products that are the subject of the query. For example, the query may request revenue data over a defined or undefined time period (e.g., as far back as data exists, or for the previous day, week, month, or year from the time of the query) for at least one product. The query may also request geographically oriented product data, such as revenue data for sales of sneaker model #123 in the United States, California, or Europe, for example. The data processing system 110 can receive the query for the report from the merchant computing device 115 after, or subsequent to, a time when the data processing system 110 obtains the ecommerce traffic data and the catalog data. For example, when the data processing system 110 receives the query, the databases 135 may already include the ecommerce traffic data and the catalog data for a product that is the subject of the query. This data can be distributed across multiple databases 135 organized by indices or keys that identify various products.

The data processing system 110 or component thereof such as the query evaluation module 125 can control or direct a plurality of the report generation servers 130 to access the ecommerce traffic data and the catalog data that is distributed among one or more databases 135 and join, merge, or integrate the data that is responsive to the query to generate the report. For example, using a key that identifies a product associated with the query, the generation module 125 can identify or direct one or more of the report generation servers 130 to join, using local memory of the report generation servers 130, ecommerce traffic data with catalog data to create joined data that can be at least temporarily stored in local memory of the report generation servers 130.

For example, the data processing system 110 can receive a query for a report for revenue data of sneaker model #123 over the past year. Responsive to the query, the query evaluation model 125 can use a key present in the query or at least one database 135 to identify or instruct one or more report generation servers 130 to locate ecommerce traffic data (e.g., a number of sales of sneaker model #123 and revenue data) and catalog data (e.g., a brand name or description of model #123 sneakers) from one or more databases 135. In some implementations, the ecommerce traffic data is stored in a first group of databases 135 and accessed by a first group of report generation servers 130, and the catalog data is stored in a second group of databases 135 (e.g., mutually exclusive from the first group of databases 135) and accessed by a second group of report generation servers 130 (e.g., mutually exclusive from the first group of report generation servers 135). Both groups of report generation servers 130 can concurrently join the ecommerce traffic data and the catalog data responsive to the query. The joined data can include ecommerce traffic data and catalog data related to sneaker model #123 obtained by one or more report generation servers from one or more databases 135.

For example, a merchant can join an analytic report service associated with the data processing system 110. The merchant, using at least one merchant computing device 115 can provide catalog data to the data processing system. The catalog data can indicate, among other information, that the merchant has two (or any other number) of products, such as model 190 123 shoes and model #456 boots. The data processing system 100 can obtain one or more instances of ecommerce traffic data indicating the sale of, for example, 5000 pairs of model #123 shoes (identified by stock keeping unit (SKU) or a product identifier) that sold for $100 per pair and 700 pairs of model #456 (identified by SKU or a product identifier) boots that sold for $75 per pair, via a plurality of merchant computing devices 115 over a period of, for example, six months. The merchant computing devices 115 can be under the direct control of the merchant, or can be third party vendors. The ecommerce traffic data and the catalog data can be stored in one or more databases 135.

The merchant, using at least one merchant computing device 115, can submit a query to the data processing system 110 for an analytical report, for example to determine total revenue related to network 105 based sales of both model 123 shoes and model #456 boots in a one report or more than one report. The data processing system 110 can select a number of the report generation servers 130 to retrieve the ecommerce traffic data and the catalog data associated with these two products from the databases 135, and can include this data as joined data in the report. The joined data can be based on or derived from both the ecommerce traffic data and the catalog data. For example, the joined data can include revenue data indicating gross revenue of (5000)*($100) for the model #123 shoes and (700)*($75) for the model #456 boots. In this example, revenue for the model #123 shoes is $500,000, and revenue from the model #456 boots is $52,500, for a total revenue over a six month period of $552,500. The report can include additional data related to model #123 shoes and model #456 boots obtained from the catalog data, such as a brand name or characteristic of these products.

In some implementations, the ecommerce traffic data includes a key and an indication of a sale or other conversion, where the key (e.g., an SKU or unique product identifier) does not overtly indicate a specific product. The data processing system 110 can use the key to find the corresponding product description in the catalog data, and can join the catalog data and the ecommerce traffic data to create the report that can overtly identify the product, for example by naming model #123 shoes or providing additional product description from the catalog data.

In some implementations, the ecommerce traffic data includes revenue data. For example, the ecommerce traffic data can indicate a sale price of a product identified by SKU or other unique product identification code or number. The catalog data can have additional data about the product, such as a name of the product (e.g., “model #123 shoes”). The joined data included in a report in this example can include revenue and sales volume information taken from the ecommerce traffic data, and can include other product information such as a name or brand of the product, taken from the catalog data.

In some implementations, the data processing system 110 does not join the data to create the report until after the data processing system 110 receives the query or request for the report. In this example, processing power or capacity of the report generation servers 130 can be reserved until after a query for a report is received. For example, if such data is pre-joined, prior to receiving a query for a report, updated or changed data may not be included in the joined data, and reprocessing the data can consume time and computational resources, increasing processing latency. By joining or loading joined ecommerce traffic and catalog data on-demand (e.g., responsive to a query for a report), the data processing system 110 avoids costs associated with storing pre-joined data in random access memory, and takes advantage of in-memory joining using memory associated with the report generation servers 130.

By receiving catalog data about several products from the merchant, via the merchant computing device 115, or from another or third party source (e.g., via the network 105) the merchant does not have to provide detailed product descriptions, names, or characteristics to the data processing system 110 with ecommerce transaction data for every sale or conversion of a product. For example, when the catalog data includes this information, the ecommerce traffic data sent to the data processing system 110 can include only a product identifier and an indicator of a sale, transaction, or other conversion that may or may not include the price paid for the product. By providing the additional meta data or product related details separately with catalog data as a single or relatively limited number of transactions, the higher volume of ecommerce transaction data transmissions (e.g., for each sale) can be smaller and simplified, reducing network bandwidth transmission requirements of the network 105 and computational resources of the data processing system 110.

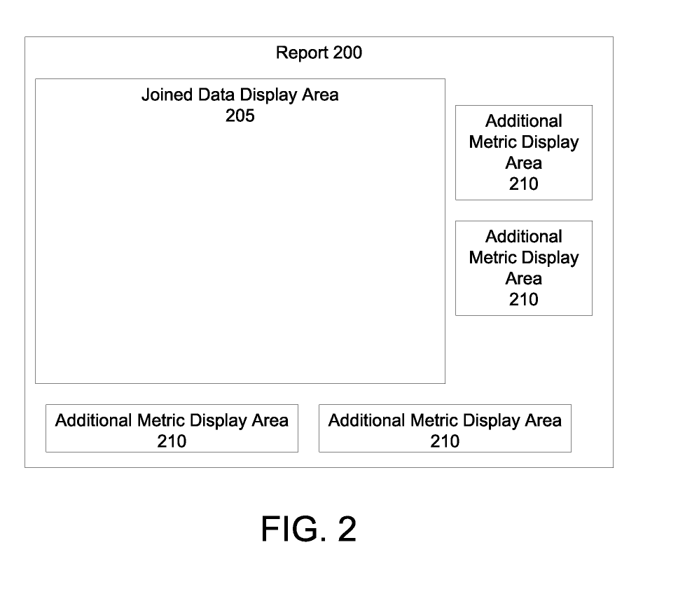

The data processing system 110 can generate the report for the product (e.g., sneaker model #123) including the joined ecommerce traffic data and catalog data. In some implementations, the data processing system 110 provides the report via the network 105 to the merchant computing device 115. FIG. 2 depicts an example analytical report 200 that can be created by the data processing system 110 and provided to the merchant computing device 115 for display by the merchant computing device 115, responsive to a query or request for a report made by the merchant computing device 115.

The report 200 can include at least one joined data display area 205. The report 200 can be in various formats, e.g., editable, interactive, or read-only. The report 200 can be displayed within a web page or other information resource rendered by the merchant computing device 115. The joined data display area 205 can include revenue, volume of products sold, volume of transactions, profit, location, or other data about a product identified in the request or query for a report. Joined data in the joined data display area 205 can be displayed in number, graphic, color coded, or visual form. The report 200 can include at least one additional metric display area 210, which can display additional information related to the product or information resources user to sell the product that is the subject of the report 200. For example, the additional metric display areas 210 can display information about other products or industry averages, as well as additional graphical, text, or visual data identifying at least one product associated with the report 200.

In some implementations, the ecommerce traffic data includes transaction event data (e.g., indicating a sale of a product) as well as revenue data (e.g., indicating a price paid for the sale), and the catalog data includes product identification data, product brand data, product characteristic data, or product cost data. The revenue data can be the same or different than the product cost data. For example, the revenue data can include a sale price, and the product cost data can include a manufacturing cost, shipping cost, or wholesale price. Responsive to a request for a report for a product, the data processing system 110 can obtain the ecommerce traffic data including the transaction event data and the revenue data, and can obtain the catalog data including at least one of the identification, product brand, product characteristic, and product cost data, and can generate a report (e.g., the report 200) including any of this data in the joined data display area 205.

The query evaluation module 125 can identify a key from the query for a report. The key can include a character string identifying at least one product. Using the key, the query evaluation module 125 (or other data processing system 110 component) can identify ecommerce traffic data associated with the product identified by the key. For example, the key or other product identifier received with the request for the report can be the same key or be indexed or mapped to the same or a different key used to identify products related to ecommerce traffic data or catalog data stored in the databases 135. The data processing system 110 can also identify the databases 135 having this ecommerce traffic data, and can identify or assign a subset of the report generation servers 130 to retrieve the ecommerce traffic data from the databases 135.

Using the key, for example, the query evaluation module 125 can identify catalog data associated with the product identified by the key. The data processing system 110 can identify the databases 135 having this catalog data, and can identify or assign a subset of the report generation servers 130 to retrieve the catalog data from the databases 135. The databases 135 having the catalog data and the ecommerce traffic data can be the same databases 135, different sets of databases 135, or partially overlapping sets of databases 135. The report generation servers 130 used to access the ecommerce traffic data or catalog data, to generate a report responsive to a query for a report, can be the same report generation servers 130, different sets of report generation servers 130, or partially overlapping sets of report generation servers 130. For example, the query evaluation module 125 or other data processing system 110 component can direct a first plurality of report generation servers 130 to generate part of a report for a product using a set of ecommerce traffic data associated with the product, and can direct a second plurality of report generation servers 130 to generate part of the report using a set of catalog data associated with the product.

The data processing system 110 can determine or select the number of report generation servers 130 used to retrieve catalog or ecommerce traffic data from the databases 135 based on the size of the data. Each selected report generation server 130 can retrieve the ecommerce traffic data or catalog data from at least one database 135 to produce the report.

The data processing system 110 can include ecommerce traffic data and catalog data for a large number of products (e.g., from hundreds to millions). Responsive to sales, the merchant computing devices 115 can provide ecommerce traffic data to the data processing system 110, and each transaction of the ecommerce traffic data can include a key identifying a product associated with the transaction. The catalog data can be provided to the data processing system 110, with keys identifying products, independent of any sales or online conversions of those products.

The data processing system 110 can organize the keys (or other identifiers), which can identify different products and different sales or other conversions, into groups, and can assign the keys and their associated ecommerce traffic data to one or more databases 135 using the groups. For example, data corresponding to the first thousand keys (e.g., keys 1-1000) can be stored, in a manner retrievable using the keys, in a first database 135 (or first group of databases 135). Data corresponding to the second thousand keys (e.g., keys 1001-2000) can be stored, in a manner retrievable using the keys, in a second database 135, or second group of databases 135. The data processing system 110 can also assign the report generation servers 130 to access the data to the databases 135. For example, the query evaluation module 125 can assign or direct a first group of report generation servers 130 to the first group of databases 135, and can assign or direct a second group of report generation servers 130 to the second group of databases 135. In some implementations, more than one key can identify the same product.

The data processing system 110 can scale to store, evaluate, or process the ecommerce traffic data and the catalog data. For example, additional report generation servers 130 or databases 135 can be added to or removed from the data processing system 100. The larger the pool of report generation servers 130, to more data they can join upon receipt of or responsive to a query for report. The query latency responsive to a query can be independent of the size of the joined ecommerce traffic or catalog data, and can be bounded instead by the number of report generation servers 130 or the size of the databases 135 included in the data processing system. When, for example, there are additional merchants requesting reports, the data processing system 110 can add additional report generation servers 130. In some implementations, the size of the ecommerce traffic data or catalog data that a report generation server 130 joins (e.g., retrieves or uses to generate a report) is bounded. Thus, the data processing system 110 scales for a large data set with bounded latency.

In some implementations, the query evaluation module 125 (or other data processing system 110 component) controls or directs the generation of a report, responsive to a query for a report, using the report generation servers 130 and the databases 135. For example, the query evaluation module 125 can scan the databases 135 to detect the key or other product identifier that identifies ecommerce traffic data and catalog data stored in the databases. The query evaluation module 125 can determine the amount of data stored in the databases 135 related to the product or to the query, (e.g., a sum of the relevant ecommerce traffic data and the catalog data), and can determine how many report generation servers 130 to use in order to access the data from the databases 135, and join the data to create the report. The query evaluation module 125 can instruct the determined number of report generation servers 130 to load the ecommerce traffic data or the catalog data to memory (e.g., local memory of the report generation servers 130) to generate the report.

The merchant, for example, can be a third party vendor that sells different brands of shoes (or another product or service) using a plurality of merchant computing devices 115 via the network 105. The merchant may sell footwear products having brand name “A” and other footwear products having brand name “B”. The multiple merchant computing devices 115 can provide ecommerce transaction data indicating sales or other conversions of the brand name “A” product or the brand name “B” product by unique product identification numbers responsive to a sale, conversion, or transaction that occurs between one of the merchant computing devices 115 and an end user computing device 120 for that product. This ecommerce traffic data may not include additional metadata or details about these products beyond a product identification code (e.g., a key) and an indication of a conversion such as a sale. At least one of the merchant computing devices 115, or a third party source, can also provide catalog data for brand name “A” and for brand name “B” to the data processing system 110.

The merchant, using a merchant computing device 115, can communicate a query for a report to the data processing system 110 requesting a report with revenue data from sales of both brand name “A” and brand name “B” via the merchant computing devices 115 associated with the merchant. In response, the data processing system 110 can join the ecommerce traffic data (e.g., individual sales data of individual products) and the catalog data (additional product description information not directly indicating a particular sale or conversion) to generate a report. The report (e.g., the report 200) can be itemized and can indicate total revenue from sales of the brand name “A” footwear product, and can also indicate total revenue from sales of the brand name “B” footwear product.

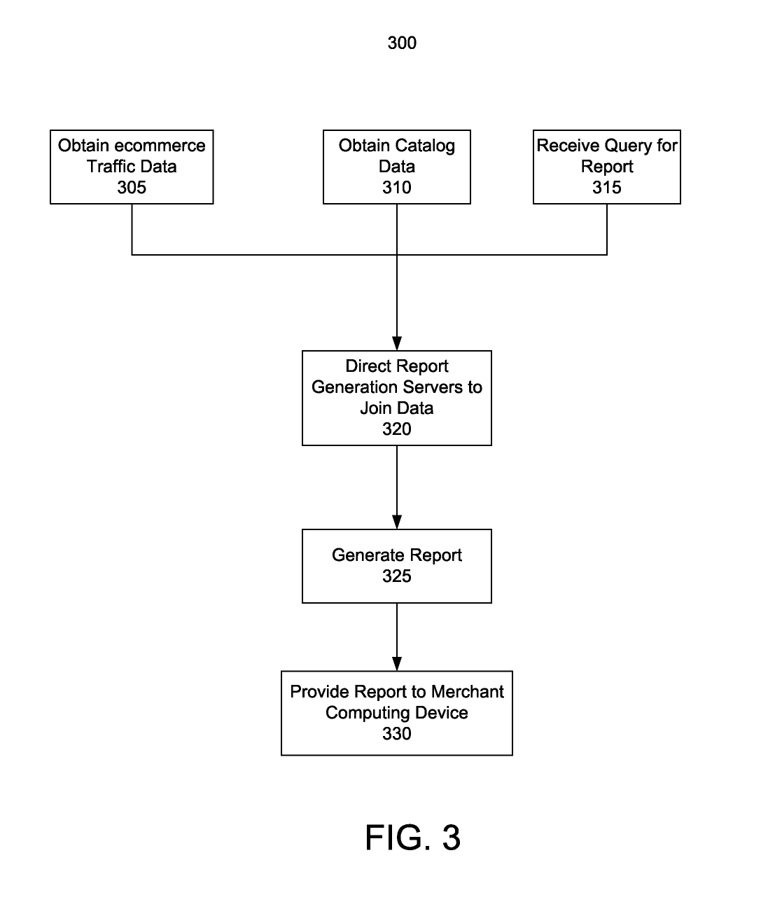

FIG. 3 depicts an example method 300 of evaluating merchant performance in a computer networked environment. The method 300 can obtain ecommerce traffic data (ACT 305). For example, the data processing system 110 can receive ecommerce traffic data from a plurality of merchant computing devices 115 indicating sales or other conversions of a plurality of products via the network 100. The data processing system 110 can organize, classify, or store the obtained ecommerce traffic data (ACT 305) in one or more databases 135 accessible by one or more report generation servers 130. The method 300 can also obtain catalog data (ACT 310). For example, the data processing system 110 can receive catalog data from a plurality of merchant computing devices 115 indicating type, characteristic, price, or other information about a plurality of products via the network 100. The data processing system 110 can organize, classify, or store the obtained catalog data (ACT 310) in one or more databases 135 accessible by one or more report generation servers 130.

The method 300 can receive at least one request for a report (ACT 315). For example, the query evaluation module 125 or other data processing system 110 component can receive a query (e.g., a request) from at least one merchant computing device 115 to generate a report (ACT 315) based on the ecommerce traffic data or the catalog data for at least one product. The query can be received (ACT 315) with at least one key or other product identifier that identifies at least one product as a subject for the report. The report can include joined data from the ecommerce traffic data and the catalog data to indicate revenue or other data related to an aggregate number of sales or other conversions of at least one product identified in the query for the report, e.g., the report 200.

The method 300 can direct report generation servers 130 to join the ecommerce traffic data and the catalog data associated with the product that is identified in the query for the report (ACT 320). For example, using a key identified from the query for the report, the query evaluation module 125 can determine which of the databases 135 include relevant ecommerce traffic data or catalog data, and can determine which report generation servers 130 should be used to join (e.g., retrieve from the databases 135 and combine) the ecommerce traffic data and the catalog data to generate the report. The method 300 can generate the report 200 (ACT 325). For example, using local memory of the report generation servers 130 or of the query evaluation module 125, the data processing system 110 can create the report 200 indicating joined data, such as total revenue for a number of a product that was sold during a time period. The report 200 can be provided to at least one merchant computing device 115 (ACT 330). For example, the data processing system 110 can provide the report 200 via the network 105 to the merchant computing device 115 for display by the merchant computing device 115, e.g., as an online document, web page, portable document or other format.

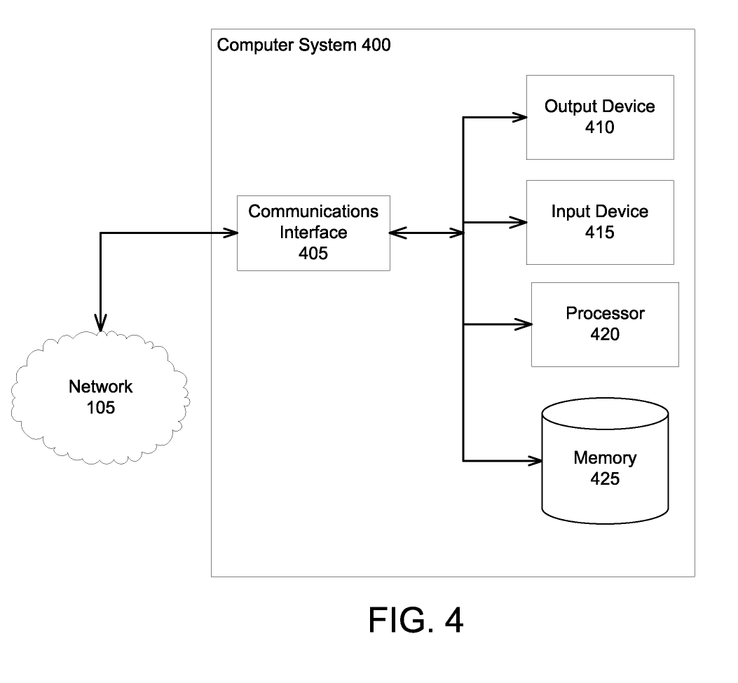

FIG. 4 shows the general architecture of an illustrative computer system 400 that may be employed to implement any of the computer systems discussed herein (including the system 100 and its components such as the data processing system 110, the query evaluation module 125 or the report generation servers 130) in accordance with some implementations. The computer system 400 can be used to provide information via the network 105, for example to request or generate a report for a merchant computing device 115. The computer system 400 includes one or more processors 420 communicatively coupled to at least one memory 425, one or more communications interfaces 405, and one or more output devices 410 (e.g., one or more display units) and one or more input devices 415. The processors 420 can be included in the data processing system 110 or the other components of the system 100 such as the query evaluation module 125 or the report generation servers 130.

The memory 425 can include databases or computer-readable storage media, and can store computer instructions such as processor-executable instructions for implementing the operations described herein. The query evaluation module 125 or the report generation servers 130, or the database 135 can include the memory 425 to store ecommerce traffic data, catalog data, or joined data as well as associated indexes or keys used to locate or obtain this data, for example. The at least one processor 420 can execute instructions stored in the memory 425 and can read from or write to the memory information processed and or generated pursuant to execution of the instructions.

The processors 420 can be communicatively coupled to or control the at least one communications interface 405 to transmit or receive information pursuant to execution of instructions. For example, the communications interface 405 can be coupled to a wired or wireless network, bus, or other communication means and can allow the computer system 400 to transmit information to or receive information from other devices (e.g., other computer systems). One or more communications interfaces 405 can facilitate information flow between the components of the system 100. In some implementations, the communications interface 405 can (e.g., via hardware components or software components) provide a website as an access portal to at least some aspects of the computer system 400. Examples of communications interfaces 405 include user interfaces.

The at least one output devices 410 can allow information to be viewed or perceived in connection with execution of the instructions. The at least one input device 615 can allow a user to make manual adjustments, make selections, enter data or other information, or interact in any of a variety of manners with the processor during execution of the instructions.

The subject matter and the operations described herein can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more modules of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing system or apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices). The operations described in this specification can be implemented as operations performed by a data processing apparatus on data stored on one or more computer-readable storage devices or received from other sources.

For situations in which the systems discussed herein collect personal information about users, or may make use of personal information, the users may be provided with an opportunity to control whether programs or features that may collect personal information (e.g., information about a user's social network, social actions or activities, a user's preferences, or a user's location), or to control whether or how to receive content from a content server or other data processing system that may be more relevant to the user. In addition, certain data may be anonymized in one or more ways before it is stored or used, so that personally identifiable information is removed when generating parameters. For example, a user's identity may be anonymized so that no personally identifiable information can be determined for the user, or a user's geographic location may be generalized where location information is obtained (such as to a city, postal code, or state level), so that a particular location of a user cannot be determined Thus, the user may have control over how information is collected about him or her and used by the content server.

The terms “data processing system” or “computing device” “module” “engine” or “component” encompasses apparatuses, devices, and machines for processing data, including by way of example a programmable processor, a computer, a system on a chip, or multiple ones, or combinations, of the foregoing. The apparatuses can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination thereof. The apparatus and execution environment can realize various different computing model infrastructures, such as web services, distributed computing and grid computing infrastructures. The query evaluation module 125 or the report generation servers 130 can include or share one or more data processing apparatuses, systems, computing devices, or processors.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program may, but need not, correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the data processing system 110) to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

The subject matter described herein can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or a combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 100 or system 400 can include clients and servers. A client and server are generally remote from each other and typically interact through a communication network (e.g., the network 105). The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server (e.g., received by the data processing system 110 from the merchant computing device 115).

While operations are depicted in the drawings in a particular order, such operations are not required to be performed in the particular order shown or in sequential order, and all illustrated operations are not required to be performed. Actions described herein can be performed in a different order.

The separation of various system components does not require separation in all implementations, and the described program components can be included in a single hardware or software product. For example, the query evaluation module 125 or the report generation servers 130 can be a single module, a logic device having one or more processing circuits, or part of one or more servers of the data processing system 110.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “an alternate implementation,” “various implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. For example, the system 100 need not be limited to merchants or other vendors of goods or services, and can be applied to a variety of data joining applications outside a commercial or merchant based environment. Scope of the systems and methods described herein is thus indicated by the appended claims, rather than the foregoing description, and changes that come within the meaning and range of equivalency of the claims are embraced therein.

What is claimed is:

1. A computer implemented method of evaluating merchant performance in a computer networked environment, comprising:
obtaining, by a data processing system having a query evaluation module and a plurality of report generation servers, via a computer network, ecommerce traffic data, the ecommerce traffic data identifying a product;
obtaining, separately from the ecommerce traffic data, by the data processing system via the computer network, catalog data not present in the ecommerce traffic data;
receiving, by the data processing system from a merchant computing device via the computer network and subsequent to obtaining both the ecommerce traffic data and the catalog data, a query for a report, the query including a key identifying the product;
directing, by the query evaluation module using the key, responsive to the query for the report, the plurality of report generation servers to join at least part of the ecommerce traffic data with at least part of the catalog data to create joined data;
generating, by the data processing system and responsive to the query for the report, the report for the product, the report including the joined data; and
providing, by the data processing system, via the computer network, the report to the merchant computing device.

2. The method of claim 1, comprising:
identifying, by the query evaluation module, a first plurality of databases associated with the ecommerce traffic data;
identifying, by the query evaluation module, a second plurality of databases associated with the catalog data; and
joining, by the data processing system, data associated with the first plurality of databases and the second plurality of databases to generate the report using a first group of the plurality of report generation servers associated with the first plurality of databases and a second group of the plurality of report generation servers associated with the second plurality of databases.

3. The method of claim 1, comprising:
concurrently joining the at least part of the ecommerce traffic data with the at least part of the catalog data to generate the report responsive to the query for the report.

4. The method of claim 1, comprising:
obtaining the ecommerce traffic data including transaction event data and revenue data;
obtaining the catalog data including at least one of product identification data, product brand data, product characteristic data, and product cost data; and
generating the report, the report including at least some of at least one of the transaction event data, the revenue data, the product identification data, the product brand data, the product characteristic data, and the product cost data.

5. The method of claim 1, comprising:
identifying the plurality of report generation servers using the key.

6. The method of claim 1, comprising:
identifying, by the query evaluation module using the key, a subset of the report generation servers as associated with the catalog data.

7. The method of claim 1, comprising:
identifying, by the query evaluation module and using the key, a subset of the ecommerce traffic data associated with the product and with a first subset of the plurality of report generation servers;
identifying, by the query evaluation module and using the key, a subset of the catalog data associated with the product and with a second subset of the plurality of report generation servers; and
generating the report using the first subset of the plurality of report generation servers and the second subset of the plurality of report generation servers.

8. The method of claim 1, comprising:
receiving, by the data processing system, the ecommerce traffic data including the key identifying the product;
storing, based on the key, the ecommerce traffic data in a database associated with a first of the plurality of report generation servers; and
directing the first of the plurality of report generation servers to generate the report using the ecommerce traffic data.

9. The method of claim 1, wherein the key is a first key and the ecommerce traffic data is associated with the first key, and the plurality of report generation servers includes a first plurality of report generation servers and a second plurality of report generation servers, comprising:
obtaining, by the data processing system, a plurality of keys each indicating ecommerce traffic data associated with one or more merchant computing devices, the plurality of keys including the first key;
organizing, by the data processing system, the plurality of keys into a first group and a second group;
storing ecommerce traffic data associated with the first group in at least one database of the first plurality of report generation servers;
storing ecommerce traffic data associated with the second group in at least one database of the second plurality of report generation servers; and
generating the report using the first plurality of report generation servers and the second plurality of report generation servers.

10. The method of claim 1, comprising:
receiving, by the data processing system, the query;
identifying, by the data processing system, at least one of the plurality of report generation servers associated with the key; and
generating the report using the at least one of the plurality of report generation servers.

11. A system of evaluating merchant performance in a computer networked environment, comprising a data processing system having a query evaluation module and a plurality of report generation servers configured to:
obtain ecommerce traffic data identifying a product;
obtaining, separately from the ecommerce traffic data, catalog data not present in the ecommerce traffic data;
receive from a merchant computing device via the computer network, a query for a report, the query including a key identifying the product;
direct, by the query evaluation module using the key, responsive to the query for the report, the plurality of report generation servers to join at least part of the ecommerce traffic data with at least part of the catalog data to create joined data;
generate, responsive to the query, the report for the product, the report including the joined data; and
provide, via the computer network, the report to the merchant computing device.

12. The system of claim 11, wherein the plurality of report generation servers includes a first plurality of report generation servers and a second plurality of report generation servers, comprising:
the query evaluation module configured to identify the first plurality of report generation servers as associated with a first plurality of databases associated with the ecommerce traffic data; and to
identify the second plurality of report generation servers as associated with a second plurality of databases associated with the catalog data; and
the data processing system configured to join data associated with the first plurality of databases and the second plurality of databases to generate the report.

13. The system of claim 11, comprising:
the plurality of report generation servers configured to concurrently generate the report responsive to the query for the report.

14. The system of claim 11, comprising the data processing system configured to:
obtain the ecommerce traffic data including transaction event data and revenue data;
obtain the catalog data including at least one of product identification data, product brand data, product characteristic data, and product cost data; and
generate the report, the report including at least some of at least one of the transaction event data, the revenue data, the product identification data, the product brand data, the product characteristic data, and the product cost data.

15. The system of claim 11, comprising:
the query evaluation module configured to identify the plurality of report generation servers using the key.

16. The system of claim 11, comprising:
the data processing system configured to identify, using the key, a subset of the report generation servers as associated with the catalog data.

17. A computer readable storage medium storing instructions that when executed by one or more data processors, cause the one or more data processors to perform operations comprising:
obtaining, via a computer network, ecommerce traffic data, the ecommerce traffic data identifying a product;
obtaining, separately from the ecommerce traffic data, via the computer network, catalog data not present in the ecommerce traffic data;
receiving, from a merchant computing device via the computer network, a query for a report, the query including a key identifying the product;
directing, responsive to the query for the report, the plurality of report generation servers to join at least part of the ecommerce traffic data with at least part of the catalog data to create joined data;
generating, responsive to the query for the report, the report for the product, the report including the joined data; and
providing, via the computer network, the report to the merchant computing device.

18. The computer readable storage medium storing of claim 17 storing instructions that when executed by one or more data processors, cause the one or more data processors to perform operations comprising:
receiving the ecommerce traffic data including a key identifying the product;
storing, based on the key, the ecommerce traffic data in a database associated with a first of the plurality of report generation servers; and
directing the first of the plurality of report generation servers to generate the report using ecommerce traffic data associated with the key.

19. The computer readable storage medium storing of claim 17 storing instructions that when executed by one or more data processors, cause the one or more data processors to perform operations, wherein the ecommerce traffic data is associated with a key, and the plurality of report generation servers includes a first plurality of report generation servers and a second plurality of report generation servers, comprising:
obtaining a plurality of keys each indicating ecommerce traffic data associated with one or more merchant computing devices;
organizing the plurality of keys into a first group and a second group;
storing ecommerce traffic data associated with the first group in at least one database of the first plurality of report generation servers;
storing ecommerce traffic data associated with the second group in at least one database of the second plurality of report generation servers; and
generating the report using the first plurality of report generation servers and the second plurality of report generation servers.

20. The computer readable storage medium storing of claim 17 storing instructions that when executed by one or more data processors, cause the one or more data processors to perform operations comprising:
receiving the query, the query associated with a key;
identifying at least one of the plurality of report generation servers associated with the key; and
generating the report using the at least one of the plurality of report generation servers.
